(19) United States
(12) Patent Application Publication
(10) Pub. No.: US 2004/0169985 A1
(43) Pub. Date: Sep. 2, 2004

(54) Integrated circuit with overvoltage protection

(76) Inventor: Martin Gropl, Sonthofen (DE)

Correspondence Address: PEARNE & GORDON LLP, 1801 EAST 9TH STREET, SUITE 1200, CLEVELAND, OH, 44114-3108, US

(21) Appl. No.: 10/652,256

(22) Filed: Aug. 29, 2003

(30) Foreign Application Priority Data
Sep. 6, 2002 (DE) 102 41 354.1

(51) Int. Cl. H02H 9/04

(52) U.S. Cl. 361/119; 361/91.1

(57) ABSTRACT

The invention relates to an integrated circuit (210) for an on-wire communication system, comprising several communication connections (C) for connecting external electrical signal lines (L), wherein an input/output circuit (IO) for inputting and/or outputting communication signals from or to the signal lines (L) is associated with each communication connection (C); wherein one of several thyristors (TY) is associated with each communication connection (C) in order to reduce any overvoltage which occurs at the respective communication connection (C) by a current flow through this thyristor (TY); wherein a control electrode (G′) of each thyristor (TY) is connected to a control circuit (CO) which detects a current flow through this thyristor (TY), and in the case of a detected current flow de-energises that input/output circuit (IO; O) which is associated with that communication connection (C; C, C′) with which this thyristor (TY) is associated. The integrated circuit is thus protected against overvoltages occurring, and is affected in a comparatively minor way by overvoltages that do occur.

### BACKGROUND TO THE INVENTION

1. Field of the Invention

The invention relates to an overvoltage protection device for microelectronic integrated circuits, in particular to an integrated circuit for an on-wire communication system comprising several communication connections for connecting external electrical signal lines.

Such an integrated circuit, for example implemented in CMOS technology, can for example be a component of a standardised communication system such as ISDN, xDSL, Ethernet, etc. which serves as an interface of a device used in such a communication system. The electrical signal lines can for example be telephone lines or special data transmission lines such as network cables, with which one or several communication channels are physically provided in the system.

Overvoltages with potentially destructive effect can arise on such circuits, in particular when such circuits are handled, by electrostatic discharges which are transmitted to the circuit when circuit connections are touched. However, overvoltages can also be caused by lightning strikes, whose current path is capacitively and/or inductively coupled to the integrated circuit or to a signal line connected to said integrated circuit.

2. Description of the State of the Art

From U.S. Pat. No. 5,682,047, an integrated circuit comprising several connections for connecting external electrical signal lines is known, wherein an input/output circuit for inputting/outputting signals from or to the signal lines is associated with each connection; and wherein a thyristor is associated with each connection, in order to reduce any overvoltage which occurs at the respective connection and which has been caused by electrostatic charge, by way of a current flow through the respective thyristor. In this arrangement, this so-called ESD protection is special in that a gate electrode, which is provided so as to be isolated from the thyristor structure, is arranged in the region of a p-n transition of the thyristor structure, for controlled induction of an electrical field in this region of the thyristor structure. By means of a coupling of this gate electrode with the circuit node to be protected, this electrical field is generated when an electrostatic overvoltage occurs, thus enabling the thyristor to be triggered at a relatively low voltage. This is necessary to protect integrated circuits with relatively low supply voltages, and would be difficult to achieve without such controlling of a gate electrode.

This known ESD protection is not at all well-suited to overvoltage protection of an integrated circuit in operation, because in the installed state of the integrated circuit, electrostatic charges practically never occur. By contrast, the danger of overvoltages due to lightning strikes dominates. Providing operational safeguards also for lightning-strike induced discharges (which as a rule are of somewhat extended duration) requires suitable dimensioning of the thyristor. Apart from this, there is a problem in that due to the voltage which during operation is present at the protected circuit node, a thyristor which has been triggered as a result of overvoltage would not return to the blocking state after the overvoltage has been reduced.

From the German patent specification DE 43 26 596 C2, a protective circuit arrangement for subscribers' electronic line circuits is known which provides protection against overvoltage on subscriber lines. This arrangement, which is constructed from discrete components, is provided for protection against overvoltages on subscriber lines, said overvoltage being due to lightning strike. Said arrangement uses a conventional cost-effective thyristor as a common current arresting element for several subscriber lines which, galvanically isolated from each other by way of respective diodes, are connected to the cathode of the thyristor whose anode is connected to a fixed reference potential. In this known protective arrangement, the control electrode of the thyristor is connected on the one hand to a control voltage by way of a resistor, and on the other hand to an input of a comparator to whose other input a reference voltage is applied. The signal provided at the output of the comparator is used for controlling all subscriber line circuits in order to de-energise these subscriber line circuits if an overvoltage is discharged, so that after decay of the overvoltage, the voltage level is below the holding current of the thyristor, so that said thyristor returns to the blocked state.

This state of the art is first of all associated with the disadvantage of very considerable circuit-technology expenditure for implementing the overvoltage protection by means of discrete components. Furthermore, this arrangement is not suitable for optimum safeguarding of several signal lines which experience different voltages during operation, e.g. in the case of signal lines on which lines signals are transmitted according to different communication standards. Finally, triggering the thyristor in this known circuit arrangement inevitably also brings about an interruption in the signal lines which have not been affected by the overvoltage—a situation which is tantamount to total failure of the data transmission.

### OUTLINE OF THE INVENTION

It is the object of the present invention to provide an integrated circuit for an on-wire communication system comprising several communication connections, which integrated circuit is protected against overvoltages occurring, and whose operation is affected as little as possible by overvoltages that nevertheless do occur.

This object is met by an integrated circuit comprising several communication connections, wherein an input/output circuit as well as a thyristor for reducing an overvoltage is associated with each communication connection, and wherein each thyristor is connected to a control circuit in order to de-energise a particular input/output circuit in the case of a current flowing through the thyristor. The dependent claims relate to advantageous improvements of the invention which improvements can be used individually or in combination.

In the integrated circuit according to the invention it is also possible for an overvoltage occurring during operation, for example an overvoltage caused by a lightning strike and transmitted towards the circuit by way of an electrical signal line, to be reliably reduced by triggering an associated thyristor. In this arrangement, several thyristors ensure that the likelihood of communication being affected overall is minimised. Since in the case of an overvoltage occurring, the associated input/output circuit too is de-energised by way of a control circuit, it can be ensured that after decay of the overvoltage the thyristor again assumes its blocking state so that communication can continue immediately after this disturbance, even if the threshold voltage (gate trigger voltage) of the thyristor as well as its holding current are relatively low (e.g. at a threshold voltage which is slightly above the voltages usually occurring during operation). Advantageously, a comparatively low threshold voltage leads to a high response sensitivity of the overvoltage protection, with the circuit according to the invention even making it possible for the threshold voltages of the thyristors, of which there are several, to be different. This is, for example, advantageous where there are several communication channels with different signal voltages or signal currents, in order to individually adapt these threshold voltages to the respectively associated thyristors.

Irrespective of this, in the circuit according to the invention the extra expenditure to implement the overvoltage protection by integration of this function in the integrated circuit is practically negligible. Large-scale integration of this lightning protection function in an IC produced in a standard technology (in particular CMOS) is possible if it is designed such that in the case of an overvoltage occurring, only little energy is released as heat in the interior of the integrated circuit.

By using a pnpn structure (thyristor), the currents can be arrested with low resistance. FIG. 5a shows an arrangement of a thyristor which is also suitable for CMOS technologies, with the arrangement being known per se. Advantageously, the thyristor is dimensioned such that the voltage necessary to maintain the current flow in the thyristor is as low as possible.

In a simple arrangement, current arresting can be provided in such a way that the anode or cathode of at least one of the thyristors is connected to a communication connection. This connection between the thyristor and the communication connection can either be direct or by way of further components (such as a diode) which in the case of overvoltage provide low-resistance arresting. Arranging a diode in this position is of interest in particular in an embodiment in which the anode or cathode of at least one of the thyristors is connected to cathodes or anodes of several diodes, and the anodes or cathodes of these diodes are connected to various communication connections so as to reduce, by means of said thyristor, overvoltages which occur at these communication connections. However, this design is unfavourable for large-scale integration in that during discharge of the lightning current, at each diode there is an additional voltage drop (on-state voltage) which is about equivalent to the voltage at the thyristor (typically approx. 1V). As a result, there is practically a doubling of heat generation when compared to a design incorporating separate thyristors.

To avoid this disadvantage, as an alternative it is possible, for reducing overvoltages on several communication connections which are equivalent with regard to the predominant operating conditions, to provide a common multiple thyristor which provides a common discharge path for these connections, and for example comprises a cathode and several anodes. FIG. 5b shows an implementation, which is known per se and which again is suitable for CMOS technologies, of a double thyristor with two anodes.

With this measure, two or more communication connections can be protected by a single (common) thyristor, for example a pair of leads or a multiple number of leads, which form one of several communication channels of the integrated circuit. If the operational voltage range of the signals on the lines of a particular communication channel is uniform, protection with a particular matched threshold voltage is advantageous. It can be achieved in a simple way by using a single thyristor (and several diodes) or by using a multiple thyristor, e.g. for safeguarding differential inputs/outputs.

Preferably, each of the communication connections is associated with precisely one of several communication channels of the integrated circuit, and each of the thyristors is associated with precisely one of the communication channels. If no thyristor is provided for discharging overvoltages on communication connections which belong to different communication channels, then channel-specific optimum threshold voltages and/or discharge resistances of the thyristors can be optimally set.

Concerning dimensioning of the threshold voltages, it is preferable if at least one of the thyristors is designed with a threshold voltage which is less than 150% of the maximum operational voltage which is present at this thyristor, in particular less than 120%.

Switching input circuits and output circuits off can be simply achieved in that at least one of the control circuits is an inverter or a comparator, whose input is connected to the control electrode of at least one of the thyristors. A binary output signal of such an inverter is suitable for a well-defined selection of the respective control circuit, wherein a delay in its output signal, which delay is generally inherent in any inverter, advantageously only causes renewed operation of the input/output circuit if the current which has been discharged by way of the thyristor has already decayed. The input of a control circuit can also be connected to control electrodes of several thyristors, in particular of thyristors which are provided for safeguarding a single communication channel.

### BRIEF DESCRIPTION OF THE DRAWINGS

Below, the invention is described in more detail by means of exemplary embodiments, with reference to the enclosed drawings.

The following are shown:

FIG. 1 three diagrammatic functional block diagrams of integrated circuits with lightning protection function;

FIG. 2 an embodiment of the circuit diagrammatically shown in FIG. 1a;

FIG. 3a an embodiment of the circuit diagrammatically shown in FIG. 1b;

FIG. 3b part of a further embodiment which uses a modification of the circuit shown in FIG. 3a;

FIG. 4 an embodiment of a further circuit comprising a multiple number of communication channels, each of which is designed to be fully differential;

FIG. 5a an implementation of a thyristor in CMOS technology; and

FIG. 5b a further implementation of a thyristor, namely a double-anode thyristor, in CMOS technology.

### DESCRIPTION OF THE PREFERRED EMBODIMENT(S)

In the following description of embodiments, essentially the same reference characters are used for analogous components, so that in the description of the individual embodiments essentially only the differences in relation to embodiments already described are discussed.

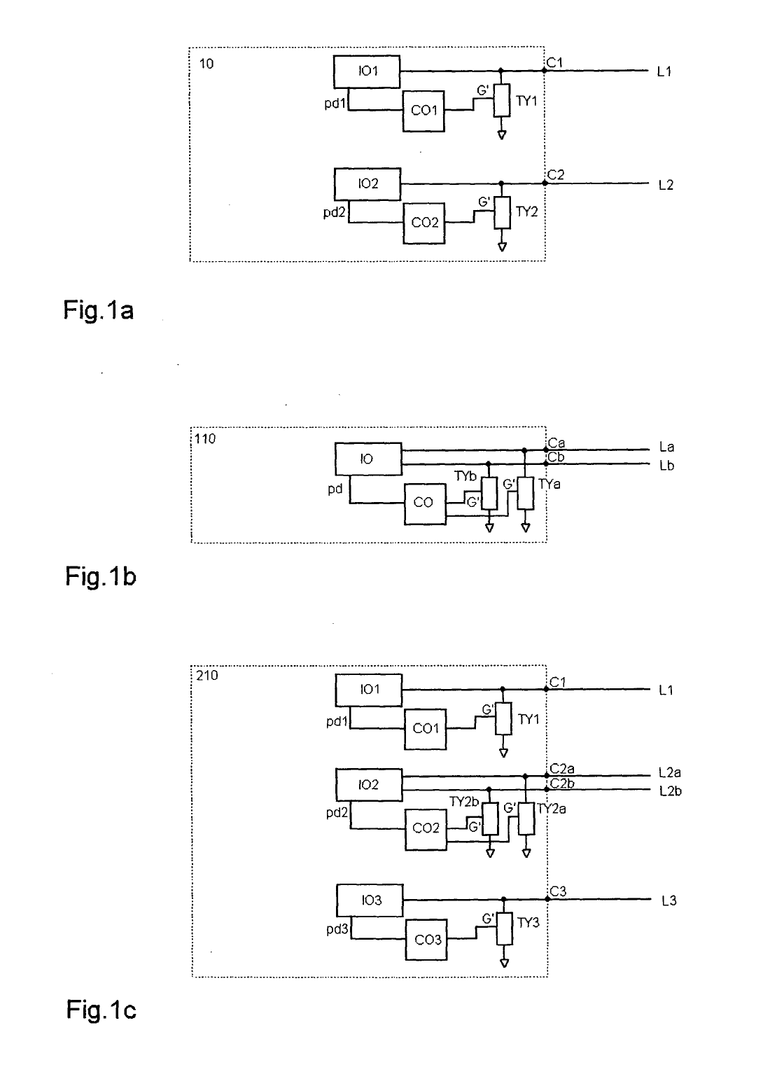

FIGS. 1a, 1b and 1c diagrammatically show integrated circuits 10, 110 and 210 for an on-wire communication system (e.g. xDSL). Each circuit comprises several communication connections for connecting external electrical signal lines. During operation of these circuits there is the danger that overvoltages caused by lightning strike enter the interior of the integrated circuit by way of these signal lines.

FIG. 1a shows an integrated circuit 10 with communication connections C1, C2, with an input/output circuit IO1 and IO2 respectively, for inputting and outputting communication signals from and to the signal lines L1 and L2 respectively being associated with each of said communication connections C1, C2. Furthermore, a thyristor TY1 or TY2 respectively is associated with each connection C1, C2, in order to reduce any overvoltage which occurs at the respective connection C1, C2 by means of a current flow through this thyristor. Depending on the polarity of the overvoltage to be reduced, either the anode or the cathode of a thyristor is directly connected to a circuit node located between the circuit IO and the connection C, while the other thyristor connection is connected to a firmly specified potential which is suitable for current arresting. Advantageously, the entire lightning protection function is implemented in the interior (see dot-dash line) of the integrated circuit 10, wherein the arrangement of a separate thyristor for each of the connections C1, C2 makes it possible to individually match the electrical characteristics of these thyristors to the operational conditions at these connections C1, C2 or at the connected signal lines L1, L2. Furthermore, the splitting of the lightning protection function between two thyristors, which splitting can be effected practically without additional expenditure in the context of IC production, makes it possible for any overvoltage-induced interruption of the communication on line L1 to not necessarily impede communication on line L2 and vice versa.

In order to make it possible to continue operation of the circuit 10 as quickly and reliably as possible after a reduction of an overvoltage which overvoltage has occurred at the connections C1 and/or C2, a control electrode G′ of each thyristor TY1, TY2 is connected to a control circuit C01, C02, which by means of the voltage which is present in that location detects and evaluates a current flow through the respective thyristor. If a current flow is detected, one of the two input/output circuits IO1, IO2 is de-energised in that those current paths between a supply potential of the circuit 10 and the respective thyristor are switched off, which current paths would prevent the thyristor which was triggered by the discharged current from returning to the non-conducting state after decay of the current pulse. To this effect, the output level of the control circuit CO1 is for example input to the input/output circuit IO1 as a binary control signal pd1. Analogously, the control circuit CO2 also provides a control signal pd2 and transmits it to the circuit IO2.

With corresponding dimensioning of the thyristors TY1, TY2, overvoltages can be discharged reliably and with minimal interruption to the circuit operation, irrespective of whether such overvoltages are caused by an electrostatic discharge or by lightning-induced influences. For a protective function that is also suitable against lightning strikes it must be taken into account that overvoltages caused by lightning strikes are usually associated with a comparatively longer duration and greater intensity of the current pulse.

In the example shown, both thyristors TY1, TY2 are used to discharge positive overvoltages at the connections C1, C2. Corresponding negative overvoltages can be reduced by arranging diodes between these connections and a suitably defined potential.

FIG. 1b shows a circuit 110, which again comprises two communication connections Ca, Cb by way of which signals from and to signal lines La, Lb are transmitted. Unlike in the embodiment previously described, these lines La, Lb, however, form a single communication channel with a particular transmission standard so that the thyristors TYa, TYb which are associated with the two connections Ca, Cb in this embodiment are advantageously dimensioned the same. Since only one input/output circuit IO is provided in this circuit 110, this circuit can be controlled by way of a single control circuit CO which on the input side is connected to the control electrodes G′ of both thyristors TY.

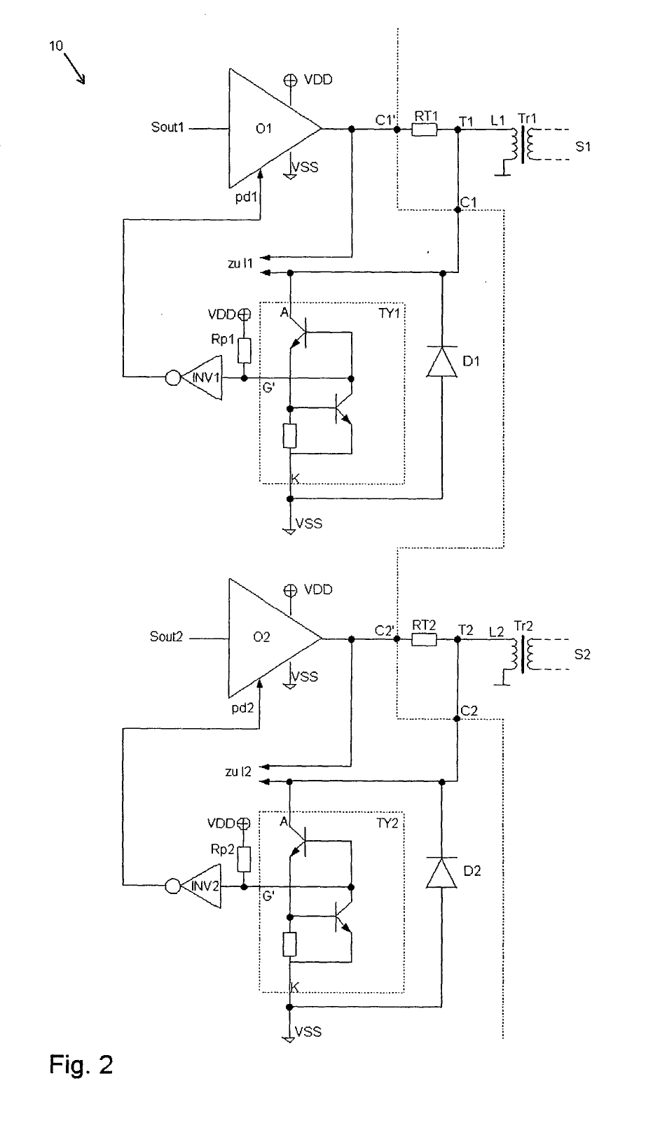

FIG. 1c shows a combination of the circuits according to FIGS. 1a and 1b. The function of the overvoltage discharge corresponds to the mechanisms which have already been described above. FIG. 2 shows in more detail the circuit 10 diagrammatically depicted in FIG. 1a (in this case an xDSL transceiver). In FIG. 2, the thyristors TY1, TY2 are shown with their normal replacement circuit diagram. The dot-dash vertical line again designates the boundary between the integrated and the non-integrated area of the circuit arrangement.

The upper part of the Figure shows the components of the first communication channel of the xDSL transceiver 10. In the non-integrated area, a communication signal S1 is transmitted via a pair of lines which on the circuit side is transmitted by way of a transformer Tr1 to the signal line L1, wherein in a way which is known per se, a line node T1 is connected to a communication connection C1′ by way of a terminating line resistor RT1, while said line node T1 is also directly connected to a second communication connection C1. Also in a way which is known per se, in this way a bi-directional data junction between the circuit 10 and the external lines is created, in which junction a signal Sout1 which is to be emitted is emitted by way of a line driver O1 fed with supply potentials VDD, VSS to connection C1′ and further by way of resistor RT1 to line L1. By contrast, a signal which is to be input to the circuit 10 by way of the external transformer Tr1 is emitted not only to connection C1′ by way of resistor RT1, but also directly to connection C1 so as to be forwarded in the circuit 10 to the input of an input circuit I1 (not shown), wherein corresponding dimensioning of the resistor RT ensures that the signal which is input to the input stage I1 (by means of weighted signal subtraction) is not impeded by a signal that is emitted at the same time.

If as a result of a lightning impulse at node T1 a positive voltage arises which is greater by a certain amount (in this example: 0.7V at VDD=+5V and VSS=−5V) than VDD, then the thyristor TY1 is triggered. As a result of this, the voltage at the node T1 is limited to a level at which no damage is caused. Consequently, at the control electrode G′ of the thyristor TY, the voltage drops from a previous level VDD to a voltage near VSS. A control circuit (sensor circuit), which can be a simple inverter INV1 as depicted in the embodiment shown, is connected to the control electrode G′ of the thyristor TY. This control circuit detects triggering of the thyristor TY, and subsequently switches off (de-energises) the line driver O1. It is immaterial whether during this action the output of the line driver O1 becomes highly resistive or whether in a low-resistance way it assumes the potential VSS.

In the example shown, the input of the inverter INV1 is furthermore connected to the positive supply potential VDD by way of a resistor RP. During undisturbed operation of the circuit 10 this sets the potential at the input of this inverter to VDD and correspondingly provides a voltage level pd1 at the output of the inverter, with said voltage level pd1 leaving the driver O1 to operate normally. If there is a current flow through the thyristor TY1, the potential at the input of the inverter drops, so that the driver O1 is deactivated.

After the current which has been discharged by way of the connection C1 and the thyristor TY1 drops, the thyristor returns to the blocked stage. As a result of this, the voltage at G′ again rises to VDD and the control circuit INV1 again switches the line driver O1 on so that immediately after the decay of the current, operation of the communication channel can be resumed. If a negative voltage occurs at the node T1, then this negative voltage is reduced by way of a diode D1 which is connected in parallel to the thyristor TY1.

The circuit component which has just been described is provided again as a second communication channel; it is shown in the lower part of FIG. 2. Unlike the first communication channel, this second communication channel is however designed for another signal voltage range on the signal line L2 in question, so that all the components shown in the lower part of the figure differ accordingly from the components of the first communication channel as far as their dimensioning is concerned, but not as far as their principal function is concerned.

In contrast to the state of the art with external lightning protection measures, with the integration of all lightning protection elements there is no longer any need to arrange elements externally in order to ensure adequate protection of the circuit against overvoltages caused by lightning strikes. Moreover, the above can be achieved essentially without additional expenditure, within the context of producing the integrated circuit.

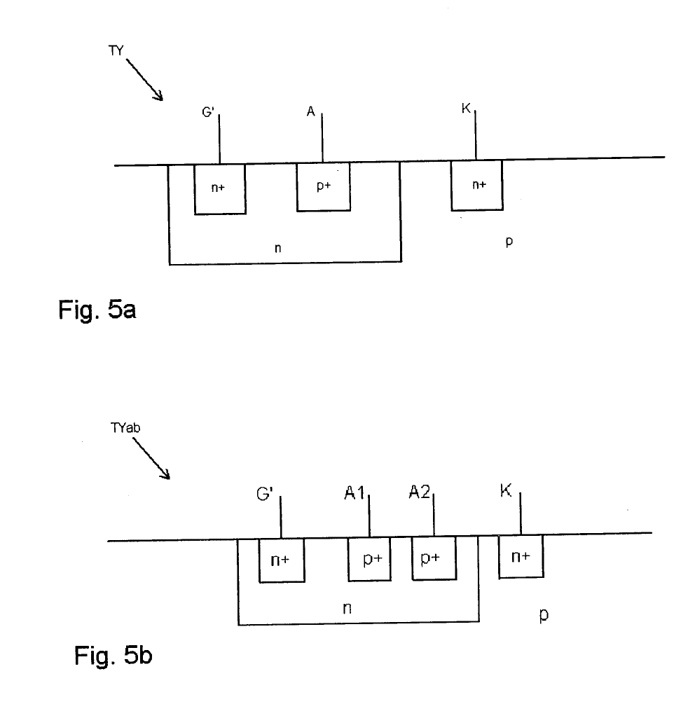

FIG. 5a shows a CMOS structure which is suitable for the design of the thyristor TY. Generally speaking, a pnpn structure in which a middle region (n or p) is contacted as a control electrode is suitable as a thyristor (compare also FIG. 5b).

Of course, instead of discharging positive overvoltages by means of a thyristor, and discharging negative overvoltages by means of a diode, a reverse arrangement can be provided in which the positive voltage is reduced by way of a diode, and the negative voltage is reduced by way of a thyristor. In this case, the pole arrangement of the thyristor and of the diode for the respective communication channel is to be reversed in relation to the embodiment shown. In this case anode A of the thyristor would contact VDD, while cathode K of the thyristor would be positioned at the transmission node T1 which is to be protected.

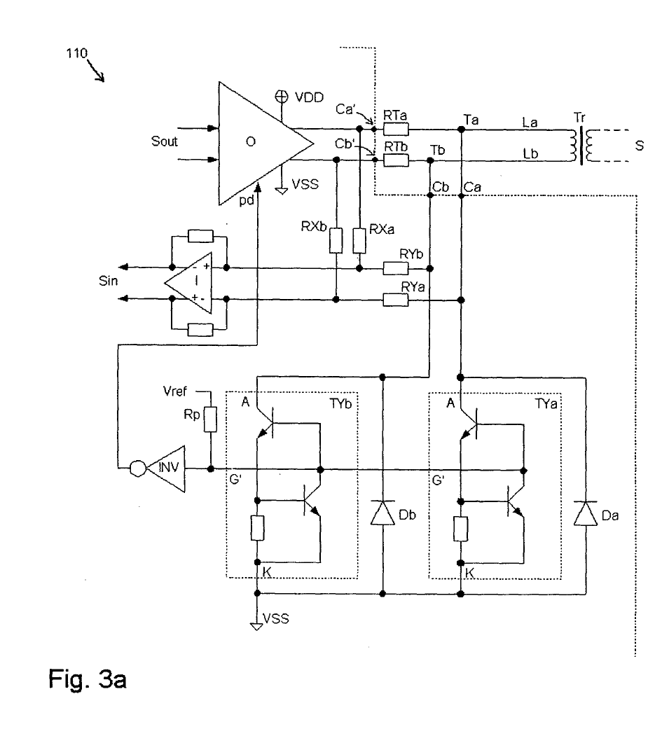

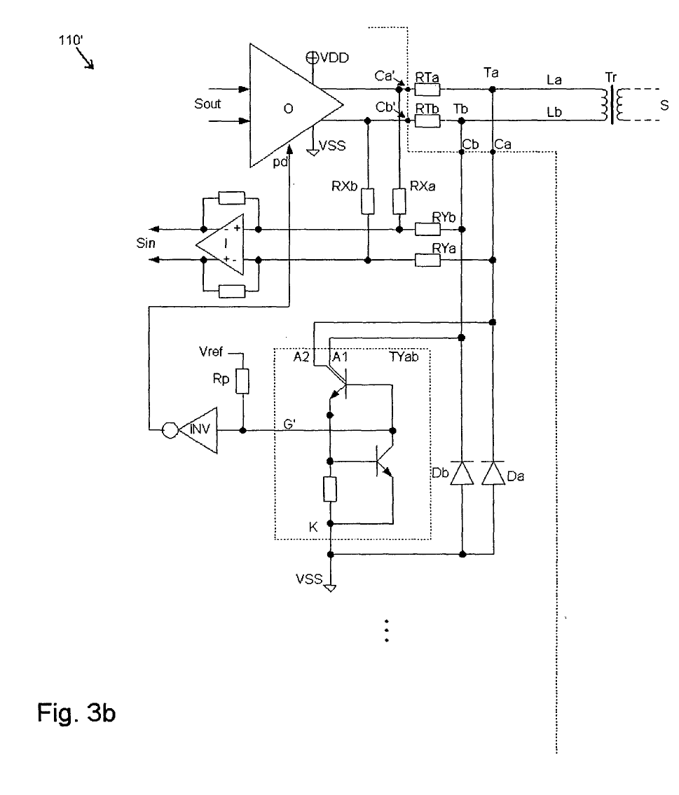

FIG. 3a shows the circuit 110 which is diagrammatically depicted in FIG. 1b in more detail. It shows that the circuit arrangement works with a fully-differential signal on lines La, Lb which by way of connections Ca, Cb, Ca′, Cb′ are again connected to an output driver O and an input circuit I in order to emit a signal Sout or receive a signal Sin. The lower part of the figure again shows the thyristors, designated TYa, TYb, for reducing positive overvoltages on lines La, Lb as well as diodes Da, Db for reducing the negative overvoltages on these lines. The control circuit for switching off the line driver O here again comprises an inverter INV, whose input is impinged upon by the potentials on both control electrodes G′, and furthermore is connected to a reference potential Vref by way of a resistor Rp. The output signal pd of the inverter is again input to a control connection of the line driver O.

FIG. 3b shows part of a further embodiment which uses a modification of the circuit shown in FIG. 3a. Shown are the circuit components in relation to a fully-differential input/output channel of an integrated circuit 110′ in which the lines La, Lb are safeguarded by a double anode thyristor TYab whose design is shown in FIG. 5b. The circuit arrangement 110′ comprises further communication connections and thyristors which are not shown.

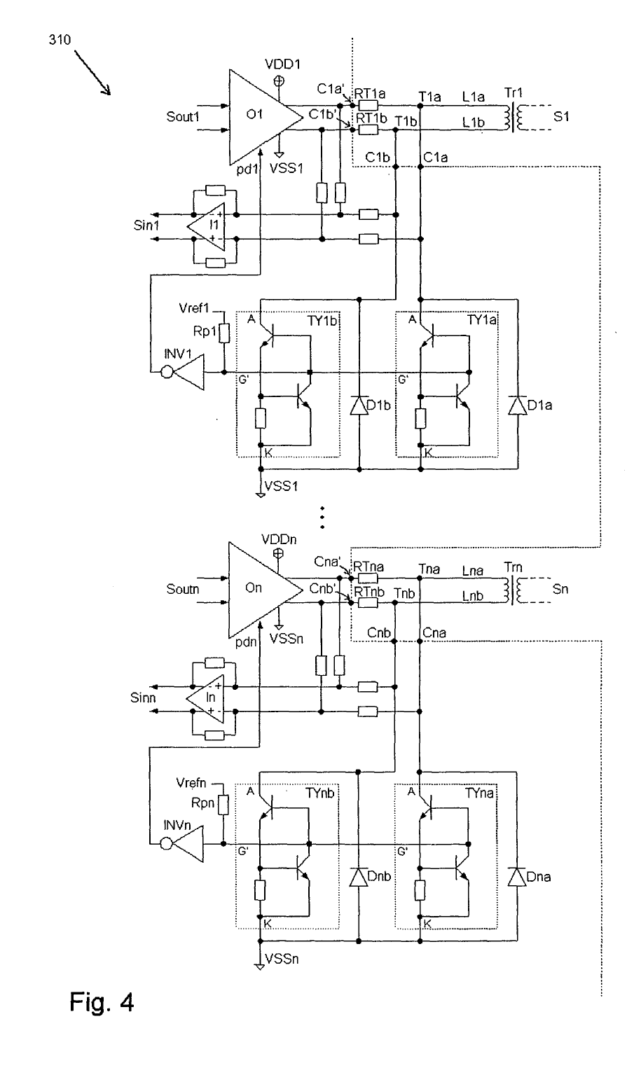

FIG. 4 shows a further embodiment of an integrated circuit 310 with a multitude (1 . . . n) of fully-differentially constructed communication channels of the type shown in FIG. 3a.

In summary, the invention provides a lightning protection function for microelectronic integrated circuits, which lightning protection function can be achieved in an almost cost-neutral way, and when used in integrated circuits with differently designed communication channels can be optimally matched by allocating respectively separate thyristors, so as to achieve communication operations with as little disturbance as possible.

1. An integrated circuit (10; 110; 110′; 210; 310) for an on-wire communication system, comprising several communication connections (C; C, C′) for connecting external electrical signal lines (L),
wherein an input/output circuit (IO; O, I) for inputting and/or outputting communication signals (S) from or to the signal lines (L) is associated with each communication connection (C; C, C′);
wherein one of several thyristors (TY) is associated with each communication connection (C; C, C′), in order to reduce any overvoltage which occurs at any one of the communication connections (C; C, C′) by a current flow through the associated thyristor (TY);
wherein a control electrode (G′) of each thyristor (TY) is connected to a control circuit (CO; INV) which detects a current flow through this thyristor (TY) and in the case of a detected current flow de-energises that input/output circuit (IO; O) which is associated with that communication connection (C; C, C′) with which this thyristor (TY) is associated.

2. The integrated circuit (10; 110; 110′; 210; 310) according to claim 1, wherein the anode (A) or cathode (K) of at least one of the thyristors (TY) is connected to a communication connection (C; C, C′), and the cathode (K) or anode (A) of this thyristor (TY) is connected to a supply potential (VDD, VSS) of the integrated circuit.

3. The integrated circuit (10; 110; 110′; 210; 310) according to claim 1, wherein the anode (A) or cathode (K) of at least one of the thyristors (TY) is connected to cathodes (K) or anodes (A)of several diodes, and the anodes (A) or cathodes (K) of these diodes are connected to various communication connections (C; C, C′) so as to reduce, by means of said thyristor (TY), overvoltages which occur at these communication connections.

4. The integrated circuit (10; 110; 110′; 210; 310) according to claim 1, wherein at least one (TYab) of the thyristors (TY) is a multiple thyristor comprising several cathodes (K) or several anodes (A), and these cathodes (K) or anodes (A) are connected to various communication connections (C; C, C′) so as to reduce, by means of said thyristor (TYab), overvoltages which occur at these communication connections.

5. The integrated circuit (10; 110; 110′; 210; 310) according to claim 1, wherein at least one of the thyristors (TY) is designed with a threshold voltage which is less than 150% of the maximum operational voltage which is present at this thyristor (TY).

6. The integrated circuit (10; 110; 110′; 210; 310) according to claim 1, wherein at least one of the control circuits (CO; INV) is an inverter, whose input is connected to the control electrode (G′) of at least one of the thyristors (TY).

7. The integrated circuit (10; 110; 110′; 210; 310) according to claim 1, wherein each of the communication connections (C; C, C′) is associated with precisely one of several communication channels of the integrated circuit, and each of the thyristors (TY) is associated with precisely one of the communication channels.
